(19) United States
(12) Patent Application Publication
(10) Pub. No.: US 2024/0073816 A1
(43) Pub. Date: Feb. 29, 2024

(54) USER EQUIPMENT AND METHOD FOR SAVING POWER

(71) Applicant: FG Innovation Company Limited, Tuen Mun (HK)

(72) Inventors: CHIA-HSIN LAI, Taipei (TW); HSIN-HSI TSAI, Taipei (TW); CHIA-HAO YU, Taipei (TW); MEI-JU SHIH, Taipei (TW)

(73) Assignee: FG Innovation Company Limited, Tuen Mun (HK)

(21) Appl. No.: 18/270,860

(22) PCT Filed: Jan. 4, 2022
(86) PCT No.: PCT/CN2022/070141

§ 371 Date: Jul. 4, 2023

Related U.S. Application Data
(60) Provisional application No. 63/133,760, filed on Jan. 4, 2021.

(51) Int. Cl. H04W 52/02

(52) U.S. Cl. CPC H04W 52/0216; H04W 52/0235

(57) ABSTRACT

A method performed by a UE for saving power is provided. The method includes: receiving, from a Base Station (BS), control information that includes a Physical Downlink Control Channel (PDCCH) monitoring adaptation field, wherein the PDCCH monitoring adaptation field indicates a PDCCH skipping function; and monitoring, regardless of the PDCCH skipping function indicated by the PDCCH monitoring adaptation field, a PDCCH in a case that a Scheduling Request (SR) is transmitted on a Physical Uplink Control Channel (PUCCH) and is determined to be pending.

### CROSS-REFERENCE TO RELATED APPLICATION(S)

The present disclosure is a National Stage Application of International Patent Application Serial No. PCT/CN2022/070141, filed on Jan. 4, 2022, which claims the benefit of and priority to U.S. Provisional Patent Application Ser. No. 63/133,760, filed on Jan. 4, 2021, the contents of all which are hereby incorporated herein fully by reference for all purposes.

### FIELD

The present disclosure is related to wireless communication, and specifically, for saving power in wireless communication system.

### BACKGROUND

Some of the abbreviations used in this disclosure include:

| Abbreviation | Full name |
|---|---|
| 3GPP | 3rd Generation Partnership Project |
| 5GC | 5G Core |
| ACK | Positive Acknowledgement |
| BA | Bandwidth Adaptation |
| BS | Base Station |
| BFR | Beam Failure Recovery |
| BSR | Buffer Status Report |
| BWP | Bandwidth Part |
| CA | Carrier Aggregation |
| CCCH | Common Control Channel |
| CE | Control Element |
| CN | Core Network |
| CORESET | Control Resource Set |
| CRC | Cyclic Redundancy Check |
| C-RNTI | Cell-Radio Network Temporary Identifier |
| CSS | Common Search Space |
| DCP | DCI with CRC scrambled by PS-RNTI |
| DCI | Downlink Control Information |
| DL | Downlink |
| DMRS | DeModulation Reference Signal |
| DRX | Discontinuous Reception |
| eNB | Evolved Node B |
| EPC | Evolved Packet Core |
| HARQ | Hybrid Automatic Repeat Request |
| ID | Identifier/Identity |
| IE | Information Element |
| LBT | Listen Before Talk |
| LSB | Least Significant Bit |
| MAC | Medium Access Control |
| MCS-C-RNTI | Modulation and Coding Scheme-Cell-Radio Network |
| | Temporary Identifier |
| MCG | Master Cell Group |
| MSB | Most Significant Bit |
| Msg⅓ | Message ⅓ |
| NR-U | New Radio Unlicensed |
| NR | New Radio |
| NW | Network |
| OFDM | Orthogonal Frequency Division Multiplexing |
| PCell | Primary Cell |
| PDCCH | Physical Downlink Control Channel |
| PDSCH | Physical Downlink Shared Channel |
| PHR | Power Headroom Report |
| PSCell | Primary Secondary Cell Group Cell |
| PS-RNTI | Power Saving-Radio Network Temporary Identifier |
| PUCCH | Physical Uplink Control Channel |
| PUSCH | Physical Uplink Shared Channel |
| RA | Random Access |
| RACH | Random Access Channel |
| RA-RNTI | Random Access-Radio Network Temporary Identifier |
| RAR | Random Access Response |
| RAN | Radio Access Network |
| Rel | Release |
| RRC | Radio Resource Control |
| SCell | Secondary Cell |
| SCG | Secondary Cell Group |
| SCS | Sub Carrier Spacing |
| SPS | Semi-Persistent Scheduling |
| SR | Scheduling Request |
| SpCell | Special Cell |
| SS | Search Space |
| TS | Technical Specification |
| UE | User Equipment |
| UL | Uplink |
| USS | UE Specific Search Space |

Various efforts have been made to improve different aspects of wireless communication for cellular wireless communication systems, such as fifth generation (5G) new radio (NR), by improving data rate, latency, reliability, and mobility in these systems. The 5G NR system is designed to provide flexibility and configurability to optimize the network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art, such as improvements in saving power for wireless communication.

### SUMMARY

The present disclosure is related to saving power in wireless communication system.

In a first aspect of the present disclosure, a method performed by a UE for saving power is provided. The method includes receiving, from a Base Station (BS), a control information that includes a field indicating a Physical Downlink Control Channel (PDCCH) monitoring adaptation function; applying the PDCCH monitoring adaptation function in one or more first Search Space (SS) sets according to the control information; and not applying the PDCCH monitoring adaptation function in one or more second SS sets according to the control information.

In an implementation of the first aspect, the PDCCH monitoring adaptation function refers to at least one of a PDCCH skipping function and an SS set group switching function.

Another implementation of the first aspect further includes performing a specific procedure, wherein the specific procedure refers to at least one of a Random Access (RA) procedure, a Scheduling Request (SR) procedure, a Beam Failure Recovery (BFR) procedure, and a procedure for Discontinuous Reception (DRX).

In another implementation of the first aspect, at least one of the one or more first SS sets refers to a UE Specific Search Space (USS).

In another implementation of the first aspect, at least one of the one or more second SS sets refers to a Type-1 PDCCH Common Search Space (CSS) or an SS set related to a Random Access (RA) procedure.

Another implementation of the first aspect further includes ignoring the field indicating the PDCCH monitoring adaptation function while not applying the PDCCH monitoring adaptation function in the one or more second SS sets.

Another implementation of the first aspect further includes initiating at least one of a first timer and a second timer while receiving the control information; applying the PDCCH monitoring adaptation function in the one or more first SS sets according to the control information if the first timer is running; and not applying the PDCCH monitoring adaptation function in the one or more second SS sets according to the control information if the second timer is running.

In another implementation of the first aspect, the first timer or the second timer is triggered if a request or a specific Medium Access Control (MAC) Control Element (CE) on a Physical Uplink Control Channel (PUCCH) is transmitted to the BS or the UE fails to receive a PDCCH corresponding to the specific MAC CE.

In a second aspect of the present disclosure, a UE in a wireless communication system for saving power is provided. The UE includes at least one processor; and at least one memory coupled to the at least one processor, wherein the at least one memory stores a computer-executable program that, when executed by the at least one processor, causes the UE to receive, from a Base station (BS), a control information that includes a field indicating a Physical Downlink Control Channel (PDCCH) monitoring adaptation function; apply the PDCCH monitoring adaptation function in one or more first SS sets according to the control information; and not applying the PDCCH monitoring adaptation function in one or more second SS sets according to the control information.

In a third aspect of the present disclosure, a method performed by a UE for saving power is provided. The method includes: receiving, from a Base Station (BS), control information that includes a Physical Downlink Control Channel (PDCCH) monitoring adaptation field, wherein the PDCCH monitoring adaptation field indicates a PDCCH skipping function; and monitoring, regardless of the PDCCH skipping function indicated by the PDCCH monitoring adaptation field, a PDCCH in a case that a Scheduling Request (SR) is transmitted on a Physical Uplink Control Channel (PUCCH) and is determined to be pending.

In an implementation of the third aspect, the PDCCH monitoring adaptation field is further used to indicate a search space (SS) set group switching function.

In an implementation of the third aspect, further includes not applying the PDCCH skipping function in a case that an RA contention resolution timer is running.

In an implementation of the third aspect, further includes monitoring, regardless of the PDCCH skipping function indicated by the PDCCH monitoring adaptation field, the PDCCH in a case that an RA contention resolution timer is running.

In an implementation of the third aspect, the control information is detected in a UE-specific search space (USS).

In a fourth aspect of the present disclosure, a UE for saving power is provided. The UE includes: one or more processors; and at least one memory coupled to the one or more processors, wherein the at least one memory stores one or more computer-executable instructions that, when executed by the one or more processors, cause the UE to: receive, from a Base Station (BS), control information that includes a Physical Downlink Control Channel (PDCCH) monitoring adaptation field, wherein the PDCCH monitoring adaptation field indicates a PDCCH skipping function; and monitor, regardless of the PDCCH skipping function indicated by the PDCCH monitoring adaptation field, a PDCCH in a case that a Scheduling Request (SR) is transmitted on a Physical Uplink Control Channel (PUCCH) and is determined to be pending.

In a fifth aspect of the present disclosure, a Base Station (BS) for saving power is provided. The BS includes: one or more processors; and at least one memory coupled to the one or more processors, wherein the at least one memory stores one or more computer-executable instructions that, when executed by the one or more processors, cause the BS to: transmit, to a User Equipment (UE), control information that includes a Physical Downlink Control Channel (PDCCH) monitoring adaptation field, wherein: the PDCCH monitoring adaptation field indicates a PDCCH skipping function; and a PDCCH is monitored, by the UE, regardless of the PDCCH skipping function indicated by the PDCCH monitoring adaptation field in a case that a Scheduling Request (SR) is received on a Physical Uplink Control Channel (PUCCH) and is determined to be pending.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a timing diagram illustrating a DRX operation, according to an example implementation of the present disclosure.

FIG. 2 is a state transition diagram illustrating an explicit SS switching mechanism for a UE, according to an example implementation of the present disclosure.

FIG. 3 is a state transition diagram illustrating an implicit SS switching mechanism for a UE, according to an example implementation of the present disclosure.

FIG. 4 is a schematic diagram illustrating identification of PDCCH monitoring occasions, according to an example implementation of the present disclosure.

FIG. 5 illustrates a schematic diagram of a PDCCH skipping mechanism, according to an example implementation of the present disclosure.

FIG. 6 is a timing diagram illustrating a DCP mechanism, according to an example implementation of the present disclosure.

FIG. 7 is a flowchart illustrating a process performed by a UE for performing SDT with a BS, according to an example implementation of the present disclosure.

FIG. 8 is a block diagram illustrating a node for wireless communication, according to an implementation of the present disclosure.

### DESCRIPTION

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the so-disclosed combination, group, series or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details such as functional entities, techniques, protocols, and standards are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof.

A software implementation may include computer-executable instructions stored on a computer-readable medium such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated circuits (ASICs), programmable logic arrays, and/or using one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR RAN typically includes at least one BS, at least one UE, and one or more optional network elements that provide connection within a network. The UE communicates with the network such as a CN, an EPC network, an Evolved Universal Terrestrial RAN (E-UTRAN), a 5GC, or an internet via a RAN established by one or more B Ss.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include but is not limited to an NB in the UMTS, an eNB in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage. The BS may be referred to as NW.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a MCG or a SCG may be called a SpCell. A PCell may refer to the SpCell of an MCG. A PSCell may refer to the SpCell of an SCG. MCG may refer to a group of serving cells associated with the Master Node (MN), comprising of the SpCell and optionally one or more SCells. An SCG may refer to a group of serving cells associated with the Secondary Node (SN), comprising of the SpCell and optionally one or more SCells.

As previously disclosed, the frame structure for NR supports flexible configurations for accommodating various next generation (e.g., 5G) communication requirements such as eMBB, mMTC, and URLLC, while fulfilling high reliability, high data rate and low latency requirements. The OFDM technology in the 3GPP may serve as a baseline for an NR waveform. The scalable OFDM numerology such as adaptive sub-carrier spacing, channel bandwidth, and CP may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following sentences, paragraphs, (sub)-bullets, points, actions, behaviors, terms, alternatives, aspects, examples, or claims described in the following invention(s) may be combined logically, reasonably, and properly to form a specific method.

Any sentence, paragraph, (sub)-bullet, point, action, behaviors, terms, alternatives, aspects, examples, or claims described in the following invention(s) may be implemented independently and separately to form a specific method.

Dependency, such as “based on”, “more specifically”, “preferably”, “in one embodiment”, “in one alternative”, “in one example”, “in one aspect”, “in one implementation”, etc., in the present disclosure is just one possible example which would not restrict the specific method.

One aspect of the present disclosure may be used, for example, in a communication, communication equipment (e.g., a mobile telephone apparatus, ad base station apparatus, a wireless LAN apparatus, and/or a sensor device, etc.), and integrated circuit (e.g., a communication chip) and/or a program, etc.

In some implementations, it is studied and concerned that extension(s) to Rel-16 DCI-based power saving adaptation during DRX Active Time for an active BWP, including PDCCH monitoring reduction when Connected-DRX (C-DRX) is configured, so as to reduce PDCCH monitoring efforts in a connected mode.

Examples of some selected terms are provided as follows.

User Equipment (UE): The UE may be referred to as PHY/MAC/RLC/PDCP/SDAP entity. The PHY/MAC/RLC/PDCP/SDAP entity may be referred to as the UE.

Network (NW): The NW may be a network node, a TRP, a cell (e.g., SpCell (Special Cell), PCell, PSCell, and/or SCell), an eNB, a gNB, and/or a base station.

Serving Cell: A PCell, a PSCell, or an SCell. The serving cell may be an activated or a deactivated serving cell.

Special Cell (SpCell): For a Dual Connectivity operation, the term Special Cell refers to the PCell of the MCG or the PSCell of the SCG depending on whether the MAC entity is associated with the MCG or the SCG, respectively. Otherwise, the term Special Cell refers to the PCell. A Special Cell supports PUCCH transmission and contention-based Random Access and is always activated.

UE Power Saving

The PDCCH monitoring activity of the UE in RRC connected mode may be governed by DRX, BA, DCP, etc.

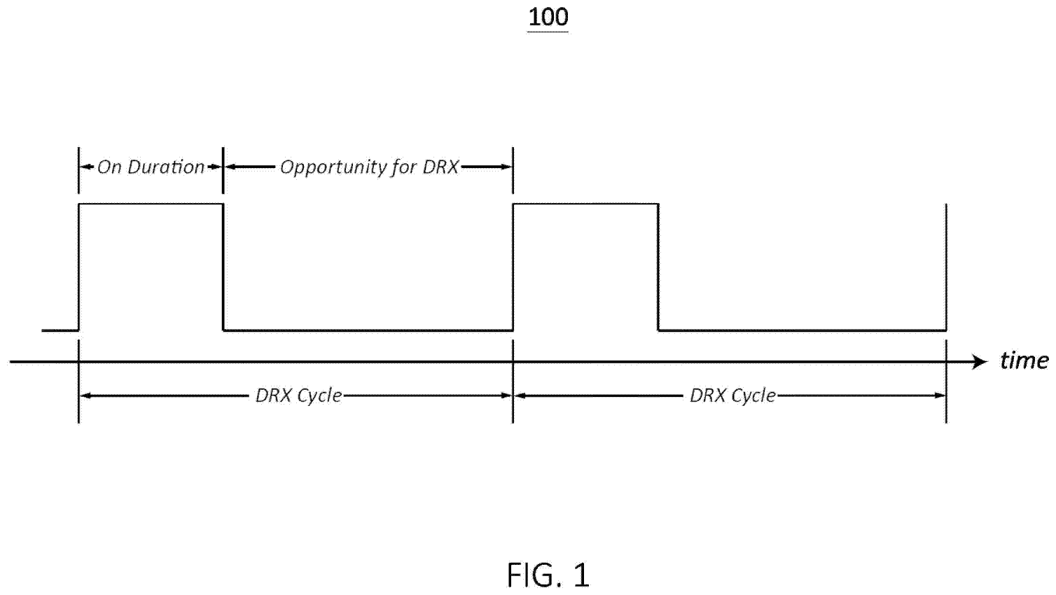

FIG. 1 is a timing diagram 100 illustrating a DRX operation, according to an example implementation of the present disclosure. When DRX is configured, the UE does not have to continuously monitor PDCCH. DRX may be characterized by the following:
(DRX) on-duration: duration in which the UE waits, after waking up, to receive PDCCHs. If the UE successfully decodes a PDCCH, the UE stays awake and starts the inactivity timer;
(DRX) inactivity-timer: duration in which the UE waits to successfully decode a PDCCH, starting from the last successful decoding of a PDCCH. If the UE fails to decode a PDCCH within this duration, the UE can go back to sleep. The UE may restart the inactivity timer following a single successful decoding of a PDCCH for a first transmission only (e.g., not for retransmissions);
(DRX) retransmission-timer: duration after which a retransmission may be expected;
(DRX) cycle: specifies the periodic repetition of the on-duration followed by a possible period of inactivity;
(DRX) active time: total duration in which the UE monitors PDCCH. This includes the “on-duration” of the DRX cycle, the time during which the UE is performing continuous reception while the inactivity timer has not expired, and the time during which the UE is performing continuous reception while waiting for a retransmission opportunity.

When BA is configured, the UE may monitor PDCCH on one active BWP. The UE does not have to monitor PDCCH on the entire DL frequency of the cell. The UE may use a BWP inactivity timer (which may be independent of the DRX inactivity-timer described above) to switch the active BWP to the default one. In some implementations, the BWP inactivity timer may be restarted upon a successful PDCCH decoding and the UE may switch to the default BWP when the BWP inactivity timer expires.

In addition, the UE may be indicated, when configured accordingly, whether it is required to monitor the PDCCH during the next occurrence of the on-duration by a DCP monitored on the active BWP. When the UE does not detect a DCP on the active BWP, the UE may not monitor the PDCCH during the next occurrence of the on-duration, unless the UE is explicitly configured to do so. The UE may only be configured to monitor DCP when connected mode DRX is configured, and at occasion(s) that have a configured offset before the on-duration. More than one monitoring occasions may be configured before the on-duration. The UE may not monitor the DCP on occasions occurring during the active-time, measurement gaps, or BWP switching, in which case the UE may monitor the PDCCH during the next on-duration. If no DCP is configured in the active BWP, the UE may follow normal DRX operation. When CA is configured, a DCP may only be configured on the PCell. One DCP may be configured to control PDCCH monitoring during an on-duration for one or more UEs independently.

In some implementations, power saving for a UE in an RRC_IDLE mode and/or in an RRC_INACTIVE mode may be achieved by having a UE relax neighboring cells' radio resource management (RRM) measurements, for example, when the UE meets one or more criteria. The one or more criteria may include the UE being in low mobility and/or not being located at a cell edge. In some implementations, UE power saving may be enabled by adapting a DL maximum number of multiple input multiple output (MIMO) layers via BWP switching. In some implementations, power saving may be enabled during an active-time via cross-slot scheduling, which may facilitate the power saving under the assumption that the UE may not be scheduled to receive a PDSCH or may not be triggered to receive an aperiodic CSI (A-CSI) or transmit a PUSCH scheduled by a PDCCH until reaching the minimum scheduling offsets (e.g., offsets K0 and K2). In some implementations, dynamic adaptation of the minimum scheduling offsets K0 and K2 may be controlled by a PDCCH.

Dynamic SS Adaptation

In NR-U, an SS set group switching feature may be introduced by which a UE may be configured to switch between sparse and frequent PDCCH monitoring. In some implementations, there are some switching mechanisms for SS set group switching, e.g., by explicit/implicit indication or by a timer. More details are presented in the following.

Explicit SS Switching

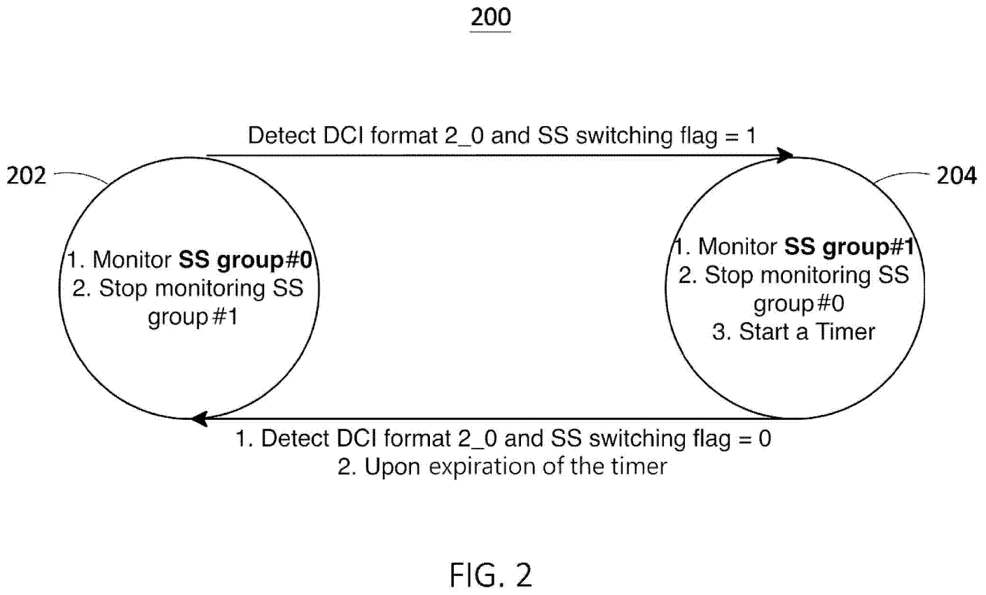

FIG. 2 is a state transition diagram 200 illustrating an explicit SS switching mechanism for a UE, according to an example implementation of the present disclosure. An explicit switching of two SS set groups may be achieved via detection of a specific DCI (e.g., DCI format 2_0). The UE may be configured with an RRC parameter, such as searchSpaceSwitchTrigger-r16. Each SearchSpaceSwitchingTrigger object provides position in DCI format 2_0 of the bit field indicating SS switching flag for a serving cell or, if CellGroupsForSwitching-r16 is configured, a group of serving cells. The bit value zero (0) of the SS switching flag may indicate a first SS set group (e.g., SS set group #0) to be monitored and the bit value one (1) of the SS switching flag may indicate the second SS set group (e.g., SS set group #1) to be monitored. More details of relevant PDCCH-Config are presented in Table 1 below.

TABLE 1

| | |
|---|---|
| PDCCH-Config ::= | SEQUENCE { |
| controlResourceSetToAddModList | SEQUENCE(SIZE (1..3)) OF ControlResourceSet |

OPTIONAL, -- Need N

| | |
|---|---|
| controlResourceSetToReleaseList | SEQUENCE(SIZE (1..3)) OF ControlResourceSetId |

OPTIONAL, -- Need N

| | |
|---|---|
| searchSpacesToAddModList | SEQUENCE(SIZE (1..10)) OF SearchSpace |

OPTIONAL, -- Need N

| | |
|---|---|
| searchSpacesToReleaseList | SEQUENCE(SIZE (1..10)) OF SearchSpaceId |

```
OPTIONAL, -- Need N
  ...,
  [[
  controlResourceSetToAddModList2-r16 SEQUENCE (SIZE (1..2)) OF ControlResourceSet
OPTIONAL, -- Need N
  controlResourceSetToReleaseList-r16 SEQUENCE (SIZE (1..5)) OF ControlResourceSetId-r16
OPTIONAL, -- Need N
```

| | |
|---|---|
| searchSpacesToAddModListExt-r16 | SEQUENCE(SIZE (1..10)) OF SearchSpaceExt-r16 |

OPTIONAL, -- Need N

| | |
|---|---|
| uplinkCancellation-r16 | SetupRelease { UplinkCancellation-r16 } |

OPTIONAL, -- Need M

| | |
|---|---|
| monitoringCapabilityConfig-r16 | ENUMERATED |

{ r15monitoringcapability,r16monitoringcapability } OPTIONAL, -- Need M

| | |
|---|---|
| searchSpaceSwitchConfig-r16 | SearchSpaceSwitchConfig-r16 |

OPTIONAL -- Need R
]]
}

| | |
|---|---|
| SearchSpaceSwitchConfig-r16 ::= | SEQUENCE { |
| cellGroupsForSwitchList-r16 | SEQUENCE(SIZE (1..4)) OF CellGroupForSwitch-r16 |

OPTIONAL, -- Need R

| | |
|---|---|
| searchSpaceSwitchDelay-r16 | INTEGER (10..52) |

OPTIONAL -- Need R
}

| | |
|---|---|
| CellGroupForSwitch-r16 ::= | SEQUENCE(SIZE (1..16)) OF ServCellIndex |

In some implementations, the list of serving cells (e.g., cellGroupsForSwitchList) are bundled for the SS group switching purpose. A serving cell may belong to only one CellGroupForSwitch. The NW may configure the same list for all BWPs of serving cells in the same CellGroupForSwitch.

In addition, more details of SlotFormatIndicator are presented in Table 2 below.

TABLE 2
The IE SlotFormatIndicator is used to configure monitoring
a Group-Common-PDCCH for Slot-Format-Indicators (SFI).

| | |
|---|---|
| SlotFormatIndicator ::= | SEQUENCE { |
| sfi-RNTI | RNTI-Value, |
| dci-PayloadSize | INTEGER (1..maxSFI-DCI-PayloadSize), |

```
  [...]
  searchSpaceSwitchTriggerToAddModList-r16 SEQUENCE (SIZE(1..4)) OF
```

| | |
|---|---|
| SearchSpaceSwitchTrigger-r16 | OPTIONAL, -- Need N |

searchSpaceSwitchTriggerToReleaseList-r16 SEQUENCE (SIZE(1..4)) OF ServCellIndex
OPTIONAL, -- Need N
[...]

| | |
|---|---|
| SearchSpaceSwitchTrigger-r16 ::= | SEQUENCE { |
| servingCellId-r16 | ServCellIndex, |
| positionInDCI-r16 | INTEGER(0..maxSFI-DCI-PayloadSize-1) |
| } | |

In some implementations, a list of SearchSpaceSwitchingTrigger objects (e.g., search S p ac e SwitchTriggerToAddModList) is provided. Each SearchSpaceSwitchingTrigger object provides position in a DCI of the bit field indicating an SS switching flag for a serving cell or (if CellGroupsForSwitching-r16 is configured) a group of serving cells.

As illustrated in FIG. 2, when the UE is in the state 202, the UE monitors SS set group #0 and stops monitoring SS set group #1. When a DCI (e.g., DCI format 2_0) is detected by the UE and the SS switching flag=1, the UE may switch from the state 202 to the state 204.

When the UE is in the state 204, the UE monitors SS set group #1 and stops monitoring SS set group #0. In some implementations, when a DCI (e.g., DCI format 2_0) is detected by the UE and the SS switching flag=0, the UE may switch from the state 204 to the state 202. In some implementations, the UE may start a timer in the state 204, and upon expiration of the timer, the UE may switch from the state 204 to the state 202.

Implicit SS Switching

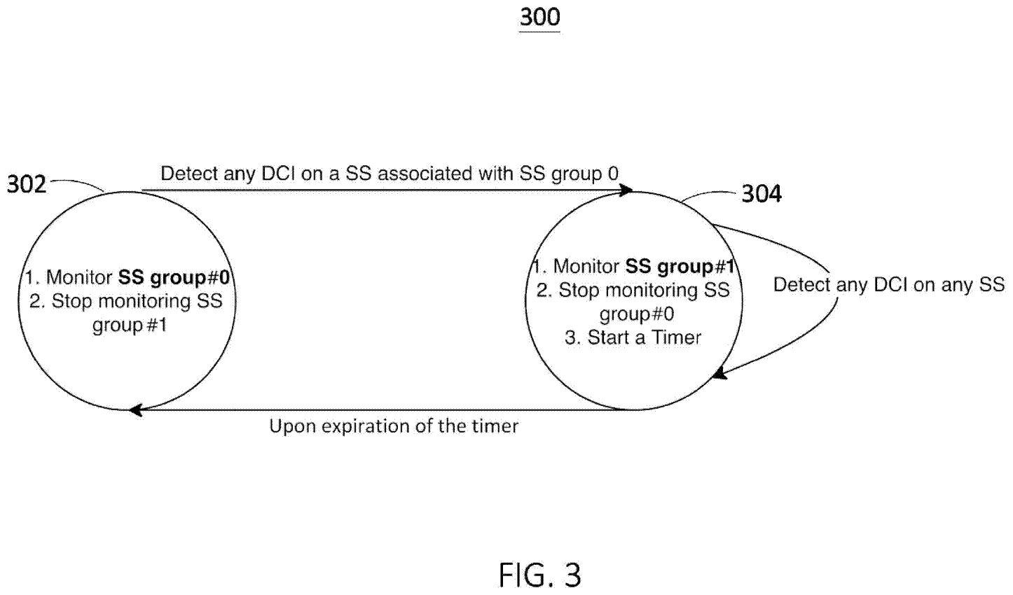

FIG. 3 is a state transition diagram 300 illustrating an implicit SS switching mechanism for a UE, according to an example implementation of the present disclosure. In some implementations, implicit SS switching may be achieved when the UE is not configured with an RRC parameter, such as searchSpaceSwitchTrigger-r16. In some implementations, implicit switching may be achieved via a DCI (not limited to DCI format 2_0) and/or a timer shown in FIG. 3.

As illustrated in FIG. 3, when the UE is in the state 302, the UE monitors SS set group #0 and stops monitoring SS set group #1. When any DCI on an SS associated with SS set group #0 is detected by the UE, the UE may switch from the state 302 to the state 304.

When the UE is in the state 304, the UE monitors SS set group #1 and stops monitoring SS set group #0. In some implementations, the UE may start a timer in the state 304, and upon expiration of the timer, the UE may switch from the state 304 to the state 302. In some implementations, the UE may not switch to the state 302 even after detecting any DCI on any SS while the timer is running. The UE may switch to the state 302 only after the timer expires.

Timer-Based SS Switching

In some implementations, a timer (e.g., searchSpaceSwitchingTimer) may be configured for SS switching. For example, the UE may (re-)start the timer when: the DCI format 2_0 is detected and the SS switching flag is set to 1, any DCI on an SS associated with SS set group #0 is detected, or any DCI on any SS is detected. Upon expiration of the timer, the UE may switch the SS to SS set group #0 (e.g., start monitoring SS set group #0 and stop monitoring SS set group #1). The timer-based SS switching may be applied to both explicit SS switching and implicit SS switching shown in FIG. 2 and FIG. 3.

Search Space Configuration Parameters

In some implementations, as basically defined in NR, a parameter monitoringSlotPeriodicityAndOffset and a parameter duration in one SearchSpace may decide the slots where the PDCCH is monitored. Further, a parameter monitoringSymbolsWithinSlot in one SearchSpace and a parameter duration in one ControlResourceSet determine the PDCCH monitoring occasion pattern within a slot.

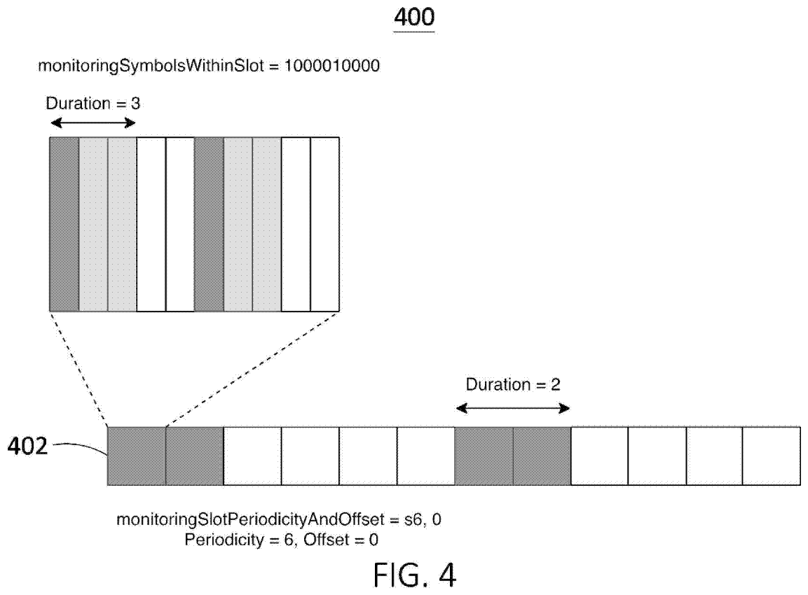

FIG. 4 is a schematic diagram 400 illustrating identification of PDCCH monitoring occasions, according to an example implementation of the present disclosure. In some implementations, the parameter monitoringSymbolsWithinSlot may have a value of “1000010000” and a duration with a value of “3” in a slot 402. In some implementations, the parameter monitoringSlotPeriodicityAndOffset may have a value of (s6, 0), indicating a periodicity of “6” and an offset of “0” with a duration having a value of “2”.

PDCCH Skipping

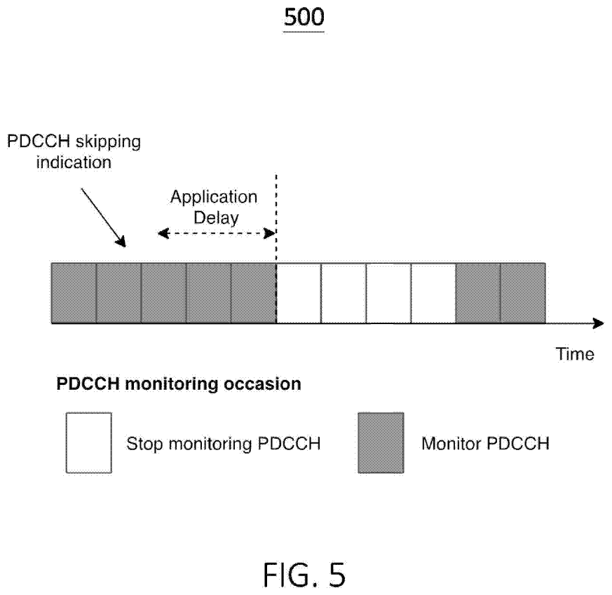

FIG. 5 illustrates a schematic diagram 500 of a PDCCH skipping mechanism, according to an example implementation of the present disclosure. In some implementations, the UE may receive a PDCCH skipping indication (e.g., containing/carrying a specific DCI format) from the NW. The PDCCH skipping mechanism may be used to indicate a duration that the UE may need to stop monitoring the PDCCH. The UE may start to apply the PDCCH skipping indication after a time period of application delay. After the duration for stop monitoring the PDCCH, the UE may restart monitoring the PDCCH as usual (e.g., when the UE is in a DRX active time). The NW may preconfigure one or more durations via a higher layer parameter (e.g., via an RRC configuration), and then the PDCCH skipping indication may indicate which duration should be applied for the PDCCH skipping mechanism.

DCI with CRC Scrambled by PS-RNTI (DCP)

In some implementations, physical layer signaling may be used to further control the PDCCH monitoring behavior for a DRX on-duration based on a configured DRX mechanism. As such, the NW may send physical layer signaling to a UE to determine whether or not the UE may wake up within a DRX on-duration (e.g., to start a drx-onDurationTimer for the next DRX cycle or not to start the drx-onDurationTimer for the next DRX cycle). The physical layer signaling may be called a DCP, or a DCI with CRC scrambled by PS-RNTI.

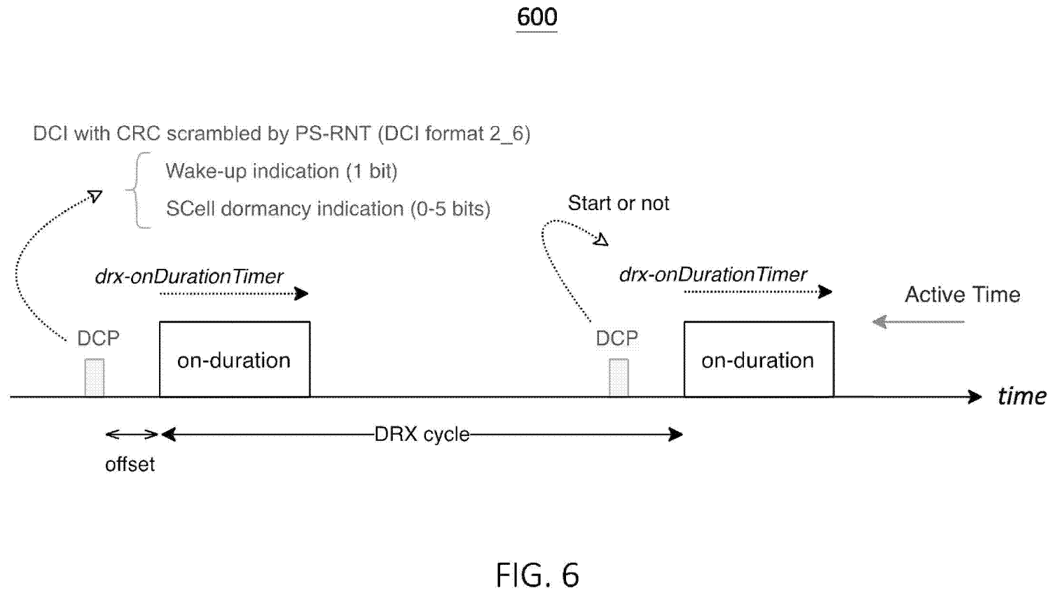

FIG. 6 is a timing diagram 600 illustrating a DCP mechanism, according to an example implementation of the present disclosure. In some implementations, the DCP mechanism in FIG. 6 may be a DCP operation with a wake-up indication. In some implementations, a DCP may be indicated by a DCI format 2_6, which may be used for notifying power saving information outside a DRX Active Time for one or more UEs. In some implementations, the DCI format 2_6 may include a “wake-up indication” (e.g., represented by 1 bit) and a “dormancy indication” (e.g., SCell dormancy indication which may be represented by 0-5 bits). The “wake-up indication” may be used to control the PDCCH monitoring behavior for an on-duration of a DRX via an on-duration timer (e.g., drx-onDurationTimer) and the “dormancy indication” may be used to control a BWP switching (e.g., entering or leaving a dormant BWP) for the serving cell(s) corresponding to a dormancy group.

Dormancy Indication

In some implementations, with regards to BWP switching for serving cell(s) of a dormancy group, the NW may group one or more serving cells (e.g., SCells) into a dormancy group and may configure one or more dormancy groups. A dormancy group configuration may be indicated by at least one of the dormancyGroupWithinActiveTime IE and dormancyGroupOutsideActiveTime IE (e.g., in ServingCellConfig). The IE dormancyGroupWithinActiveTime or dormancyGroupOutsideActiveTime may contain an ID of a dormancy group within or outside an active time to which the serving cell may belong. In some implementations, an IE maxNrofDormancyGroups may determine the quantity of groups configured for a Cell Group. In some implementations, when a dormancy group(s) is configured, the NW may switch the BWPs for all the serving cells in the dormancy group(s) entering or leaving a dormant BWP via a signaling (e.g., DCI format 2_6, DCI format 0_1, DCI format 1_1, etc.).

SS Space Set Group Switching

In some implementations, a UE may be provided a group index for a respective Type-3 PDCCH CSS set or a USS set by a parameter searchSpaceGroupIdList-r16 for the PDCCH monitoring on a serving cell. If the UE is not provided with the parameter searchSpaceGroupIdList-r16 for an SS set, some of the following procedures may not be applicable for the PDCCH monitoring according to the SS set.

In some implementations, if a UE is provided with the parameter searchSpaceSwitchingGroupList-r16, indicating one or more groups of serving cells, some following procedures may apply to all serving cells within each group; otherwise, the following procedures may apply only to a serving cell for which the UE is provided with the parameter searchSpaceGroupIdList-r16.

In some implementations, when a UE is provided with the parameter searchSpaceGroupIDList-r16, the UE may reset the PDCCH monitoring according to the SS sets with a group index 0, if the SS sets with the group index 0 is provided through the parameter searchSpaceGroupIdList-r16.

In some implementations, a UE may be provided, through the parameter searchSpaceSwitchingDelay-r16, a number of symbols P_{switch}, where a minimum value of P_{switch} is provided in Table 3 below for UE processing capability 1 and UE processing capability 2 and SCS configuration μ. The UE processing capability 1 for SCS configuration μ applies unless the UE indicates support for the UE processing capability 2.

TABLE 3

| | Minimum P_{switch} value for | Minimum P_{switch} value for |
|---|---|---|
| | UE processing capability 1 | UE processing capability 2 |
| μ | [symbols] | [symbols] |
| 0 | 25 | 10 |
| 1 | 25 | 12 |
| 2 | 25 | 22 |

In some implementations, a UE may be provided, through the parameter searchSpaceSwitchingTimer-r16, a timer value for a serving cell that the UE is provided the parameter searchSpaceGroupIdList-r16 or, if provided, for a set of serving cells provided by the parameter searchSpaceSwitchingGroupList-r16. The UE may decrement the timer value by one after each slot based on a reference SCS configuration that is the smallest SCS configuration μ among all configured DL BWPs in the serving cell, or in the set of serving cells. The UE may maintain the reference SCS configuration during the timer decrement procedure.

In some implementations, if a UE is provided through the parameter SearchSpaceSwitchTrigger-r16 a location of an SS set group switching flag field for a serving cell in a DCI format 2_0, as introduced in 3GPP TS, more conditions are introduced in the following: if the UE detects a DCI format 2_0 and a value of the SS set group switching flag field in the DCI format 2_0 is 0, the UE may start monitoring the PDCCH according to the SS sets with group index 0, and may stop monitoring the PDCCH according to the SS sets with group index 1, on the serving cell at a first slot that is at least P_{switch} symbols after the last symbol of the PDCCH with the DCI format 2_0;
if the UE detects a DCI format 2_0 and a value of the SS set group switching flag field in the DCI format 2_0 is 1, the UE may start monitoring the PDCCH according to the SS sets with group index 1, and may stop monitoring the PDCCH according to the SS sets with group index 0, on the serving cell at a first slot that is at least P_{switch} symbols after the last symbol of the PDCCH with the DCI format 2_0, and the UE may set the timer value to a value provided by the parameter searchSpaceSwitchingTimer-r16;
if the UE monitors the PDCCH on a serving cell according to the SS sets with group index 1, the UE may start monitoring the PDCCH on the serving cell according to the SS sets with group index 0, and may stop monitoring the PDCCH according to the SS sets with group index 1, on the serving cell at the beginning of the first slot that is at least P_{switch} symbols after a slot, where the timer expires, or after a last symbol of a remaining channel occupancy duration for the serving cell that is indicated by the DCI format 2_0.

In some implementations, if a UE is not provided with the parameter SearchSpaceSwitchTrigger-r16 for a serving cell,
if the UE detects a DCI format by monitoring the PDCCH according to the SS set with group index 0, the UE may start monitoring the PDCCH according to the SS sets with group index 1, and may stop monitoring the PDCCH according to the SS sets with group index 0, on the serving cell at a first slot that is at least P_{switch} symbols after the last symbol of the PDCCH with the DCI format, the UE may set the timer value to a value provided by the parameter searchSpaceSwitchingTimer-r16 if the UE detects a DCI format by monitoring the PDCCH in any SS set;
if the UE monitors the PDCCH on a serving cell according to the SS sets with group index 1, the UE may start monitoring the PDCCH on the serving cell according to the SS sets with group index 0, and may stop monitoring the PDCCH according to the SS sets with group index 1, on the serving cell at the beginning of the first slot that is at least P_{switch} symbols after a slot, where the timer expires, or if the UE is provided an SS set to monitor the PDCCH for detecting a DCI format 2_0, after a last symbol of a remaining channel occupancy duration for the serving cell that is indicated by the DCI format 2_0.

In some implementations, a UE may determine a slot and a symbol therein to start or stop the PDCCH monitoring according to SS sets for a serving cell that the UE is provided the parameter searchSpaceGroupIdList-r16 or, if the parameter searchSpaceSwitchingGroupList-r16 is provided, for a set of serving cells, based on the smallest SCS configuration μ among all configured DL BWPs in the serving cell or in the set of serving cells and, if any, in the serving cell, where the UE receives a PDCCH and detects a corresponding DCI format 2_0 triggering the start/stop of the PDCCH monitoring according to SS sets.

PDCCH monitoring indication and dormancy/non-dormancy behavior for SCells

In some implementations, a UE configured with a DRX mode operation may be provided with the following for detection of a DCI format 2_6 in a PDCCH reception on the PCell or on the SpCell:
a PS-RNTI for the DCI format 2_6 by a ps-RNTI;
a number of SS sets, by a dci-Format2-6, to monitor the PDCCH for detection of the DCI format 2_6 on the active DL BWP of the PCell or of the SpCell according to a CSS;
a payload size for the DCI format 2_6 by a sizeDCI_2-6;
a location in the DCI format 2_6 of a Wake-up indication bit by a psPositionDCI-2-6, including a ‘0’ value for a Wake-up indication bit, when reported to higher layers, for indicating to not start a drx-onDurationTimer for a next long DRX cycle; or a ‘1’ value for the Wake-up indication bit, when reported to higher layers, for indicating to start the drx-onDurationTimer for the next long DRX cycle; a bitmap, when the UE is provided a number of groups of configured SCells by a parameter Scell-groups-for-dormancy-outside-active-time, where:
   the bitmap location is immediately after the Wake-up indication bit location;
   the bitmap size is equal to the number of groups of configured SCells, where each bit of the bitmap corresponds to a group of configured SCells from the number of groups of configured SCells;
   a ‘0’ value for a bit of the bitmap indicates an active DL BWP, provided by a parameter dormant-BWP, for the UE for each activated SCell in the corresponding group of configured SCells;
   a ‘1’ value for a bit of the bitmap indicates:
      an active DL BWP, provided by a parameter first-non-dormant-BWP-ID-for-DCI-outside-active-time, for the UE for each activated SCell in the corresponding group of configured SCells, if a current active DL BWP is the dormant DL BWP;
      a current active DL BWP, for the UE for each activated SCell in the corresponding group of configured SCells, if the current active DL BWP is not the dormant DL BWP;
an offset by a parameter ps-Offset indicating a time, where the UE starts monitoring the PDCCH for detection of the DCI format 2_6 according to the number of SS sets, prior to a slot where the drx-onDuaration Timer may start on the PCell or on the SpCell;
   for each SS set, the PDCCH monitoring occasions are the ones in the first T s slots indicated by a parameter duration, or Tₛ=1 slot if the parameter duration is not provided, starting from the first slot of the first Tₛ slots and ending prior to the start of the drx-onDurationTimer.

In some implementations, on the PDCCH monitoring occasions associated with a same long DRX Cycle, a UE does not expect to detect more than one DCI format 2_6 with different values of the Wake-up indication bit for the UE or with different values of the bitmap for the UE. In some implementations, the UE does not monitor the PDCCH for detecting the DCI format 2_6 during Active Time.

In some implementation, if a UE reports for an active DL BWP a requirement of X slots prior to the beginning of a slot, where the UE may start the drx-onDurationTimer, the UE may not be required to monitor the PDCCH for detection of the DCI format 2_6 during the X slots, where X corresponds to the requirement of the SCS of the active DL BWP in Table 4 below.

TABLE 4

Minimum Time Gap X (slots)

| SCS (kHz) | Value 1 | Value 2 |
|---|---|---|
| 15 | 1 | 3 |
| 30 | 1 | 6 |
| 60 | 1 | 12 |
| 120 | 2 | 24 |

In some implementation, if a UE is provided with SS sets to monitor the PDCCH for detection of the DCI format 2_6 in the active DL BWP of the PCell or of the SpCell and the UE detects the DCI format 2_6, the physical layer of the UE may report the value of the Wake-up indication bit for the UE to higher layers for the next long DRX cycle.

In some implementation, if a UE is provided with SS sets to monitor the PDCCH for detection of the DCI format 2_6 in the active DL BWP of the PCell or of the SpCell and the UE does not detect the DCI format 2_6, the physical layer of the UE may not report a value of the Wake-up indication bit to higher layers for the next long DRX cycle.

In some implementation, if a UE is provided with SS sets to monitor the PDCCH for detection of the DCI format 2_6 in the active DL BWP of the PCell or of the SpCell and the UE is not required to monitor the PDCCH for detection of the DCI format 2_6 for all corresponding PDCCH monitoring occasions outside an Active Time prior to a next long DRX cycle (or the UE does not have any PDCCH monitoring occasions for detection of the DCI format 2_6 outside the Active Time of a next long DRX cycle), the physical layer of the UE may report a value of 1 for the Wake-up indication bit to higher layers for the next long DRX cycle.

In some implementations, if a UE is provided with SS sets to monitor the PDCCH for detection of the DCI format 0_1 and the DCI format 1_1 and if at least one of the DCI format 0_1 and the DCI format 1_1 include an SCell dormancy indication field, more conditions are introduced in the following:
the SCell dormancy indication field is a bitmap with size equal to a number of groups of configured SCells, provided by a parameter Scell-groups-for-dormancy-within-active-time;
each bit of the bitmap corresponds to a group of configured SCells from the number of groups of configured SCells;
if the UE detects a DCI format 0_1 or a DCI format 1_1 that does not include a carrier indicator field, or detects a DCI format 0_1 or DCI format 1_1 that includes a carrier indicator field with value equal to 0;
a ‘0’ value for a bit of the bitmap indicates an active DL BWP, provided by a parameter dormant-BWP, for the UE for each activated SCell in the corresponding group of configured SCells;
a ‘1’ value for a bit of the bitmap indicates:
   an active DL BWP, provided by a parameter first-non-dormant-BWP-ID-for-DCI-inside-active-time, for the UE for each activated SCell in the corresponding group of configured SCells, if a current active DL BWP is the dormant DL BWP;
   a current active DL BWP, for the UE for each activated SCell in the corresponding group of configured SCells, if the current active DL BWP is not the dormant DL BWP;
the UE sets the active DL BWP to the indicated active DL BWP.

In some implementations, if a UE is provided with SS sets to monitor the PDCCH for detection of the DCI format 1_1, and if the CRC of the DCI format 1_1 is scrambled by a C-RNTI or a MCS-C-RNTI, and if a one-shot HARQ-ACK request field is not present or has a ‘0’ value, and if
the UE detects a DCI format 1_1 on the primary cell that does not include a carrier indicator field, or detects a DCI format 1_1 on the primary cell that includes a carrier indicator field with value equal to 0, and if
a parameter resourceAllocation=resourceAllocationType0 and all bits of the frequency domain resource assignment field in the DCI format 1_1 are equal to 0, or
a parameter resourceAllocation=resourceAllocationType1 and all bits of the frequency domain resource assignment field in the DCI format 1_1 are equal to 1, or
a parameter resourceAllocation=dynamicSwitch and all bits of the frequency domain resource assignment field in the DCI format 1_1 are equal to 0 or 1;
Then the UE considers the DCI format 1_1 as indicating the SCell dormancy, not scheduling a PDSCH reception or indicating an SPS PDSCH release, and for transport block 1 interprets the sequence of fields of
   modulation and coding scheme,
   new data indicator,
   redundancy version;
and of
   HARQ process number,
   antenna port(s),
   DMRS sequence initialization;
as providing a bitmap to each configured SCell, in an ascending order of the SCell index, where
   a ‘0’ value for a bit of the bitmap indicates an active DL BWP, provided by the dormant-BWP, for the UE for a corresponding activated SCell;
   a ‘1’ value for a bit of the bitmap indicates:
      an active DL BWP, provided by the first-non-dormant-BWP-ID-for-DCI-inside-active-time, for the UE for a corresponding activated SCell, if a current active DL BWP is the dormant DL BWP;
      a current active DL BWP, for the UE for a corresponding activated SCell, if the current active DL BWP is not the dormant DL BWP;
   the UE sets the active DL BWP to the indicated active DL BWP.

In some implementations, if an active DL BWP provided by the dormant-BWP for a UE on an activated SCell is not a default DL BWP for the UE on the activated SCell, the BWP inactivity timer is not used for transitioning from the active DL BWP provided by the dormant-BWP to the default DL BWP on the activated SCell.

In some implementations, a UE is expected to provide HARQ-ACK information in response to a detection of a DCI format 1_1 indicating an SCell dormancy after N symbols from the last symbol of a PDCCH providing the DCI format 1_1. If a parameter processingType2Enabled of PDSCH-ServingCellConfig is set to ‘enable’ for the serving cell with the PDCCH providing the DCI format 1_ 1, N=5 for μ=0, N=5.5 for μ=1, and N=11 for μ=2; otherwise, N=10 for μ=0, N=12 for μ=1, N=22 for μ=2, and N=25 for μ=3, where μ is the smallest SCS configuration between the SCS configuration of the PDCCH providing the DCI format 1_1 and the SCS configuration of a PUCCH with the HARQ-ACK information in response to the detection of the DCI format 1_1.

DCI Format 2_6

In some implementations, the DCI format 2_6 is used for notifying the power saving information outside DRX Active Time for one or more UEs. The following information is transmitted by means of the DCI format 2_6 with the CRC scrambled by the PS-RNTI:
block number 1, block number 2, . . . , block number N, where the starting position of a block is determined by the parameterps-PositionDCI-2-6 provided by higher layers for the UE configured with the block.

In some implementations, if the UE is configured with higher layer parameter PS-RNTI and dci-Format2-6, one block is configured for the UE by higher layers, with the following fields defined for the block:
Wake-up indication—1 bit
Dormancy indication—0 bit if a higher layer parameter Scell-groups-for-dormancy-outside-active-time is not configured; otherwise 1, 2, 3, 4 or 5 bits bitmap determined according to the higher layer parameter Scell-groups-for-dormancy-outside-active-time, where each bit corresponds to one of the SCell group(s) configured by the higher layers parameter Scell-groups-for-dormancy-outside-active-time, with MSB to LSB of the bitmap corresponding to the first to last configured SCell group. The size of DCI format 2_6 is indicated by the higher layer parameter sizeDCI-2-6.

DCI Format 0_1

In some implementations, the DCI format 0_1 is used for scheduling of one or multiple PUSCHs in one cell, or indicating Configured Grant-Downlink Feedback Information (CG-DFI) to a UE.

DCI Format 1_1

In some implementations, the DCI format 1_1 is used for scheduling of PDSCH in one cell.

Issues

Specifically, some implementations are introduced to improve and/or solve the following issues. In some implementations, if/when a UE receives/decodes/detects a PDCCH, which may contain/carry a specific DCI format, indicating a PDCCH skipping and/or an SS set (group) switching and/or an SCell dormancy, which SS set (group) the UE may skip monitoring should be determined. In some implementations, if/when a UE receives/decodes/detects a PDCCH, which may contain/carry a specific DCI format, indicating a PDCCH skipping and/or an SS set (group) switching and/or an SCell dormancy, when the UE may start the PDCCH skipping and/or the SS set (group) switching and/or the SCell dormancy should be determined. Specifically, when the UE receives the PDCCH, the UE may apply an indication of the PDCCH after an application delay. In some implementations, if/when a UE receives/decodes/detects a PDCCH, which may contain/carry a specific DCI format, indicating a PDCCH skipping, and the UE is performing some specific procedures (e.g., a BFR procedure, a RA procedure, and/or an SR procedure), which PDCCH occasions the UE may skip monitoring and/or which PDCCH occasions the UE may not skip should be determined. In some implementations, if/when a UE receives/decodes/detects a PDCCH, which may contain/carry a specific DCI format, indicating a PDCCH skipping and/or an SS set (group) switching and/or an SCell dormancy, and the UE is performing some specific procedures (e.g., a BFR procedure, a RA procedure, and/or an SR procedure), when the UE may start to apply the PDCCH skipping and/or the SS set (group) switching and/or the SCell dormancy should be determined. Specifically, when the UE receives the PDCCH, the UE may apply an indication of the PDCCH after an application delay.

### Detailed Embodiments

In some implementations, if/when a UE receives/decodes/detects a PDCCH with control information in a first active DL BWP of a first serving cell, the UE may stop monitoring at least one of (or may not monitor or may skip monitoring) a first number of PDCCH occasion(s), a first number of time units (e.g., symbol, mini-slot, sub-slot, slot, msec, sec, DRX cycles), a first number of SS set(s), and a first number of SS set group(s)) in the first active DL BWP of the first serving cell and/or in one or some second BWPs of one or some second serving cells for a time duration. The UE may stop monitoring (or may not monitor or may skip monitoring) a first number of PDCCH occasion(s) (or a first number of time units (e.g., symbol, mini-slot, sub-slot, slot, msec, sec, DRX cycles), or a first number of SS set(s), or a first number of SS set group(s)) in the second BWP of the one or some second serving cells for the time duration at least a time offset after receiving at least one of the control information and the PDCCH.

Specifically, in one implementation, the PDCCH with the control information may be a PDCCH skipping indication. In another implementation, the first number may be (pre-)configured by RRC parameters and/or be indicated by the PDCCH. In another implementation, the second serving cell(s) may be (pre-)configured by RRC parameters (e.g., via a cell index and/or a cell list) or be indicated by the PDCCH (e.g., via a cell index). In another implementation, the second serving cell(s) may be (pre-)configured by RRC parameters (e.g., via a cell group and/or cell list), and the PDCCH may indicate which cell group and/or cell list via a bit-map. In another implementation, a reference time for starting the time offset may be a first symbol or a last symbol that carries the control information.

In some implementations, if/when a UE receives/decodes/detects a PDCCH with a control information in a first active DL BWP of a first serving cell, the UE may stop monitoring (or may skip monitoring or may only monitor) a first number of PDCCH occasion(s) (or a first number of time units (e.g., symbol, mini-slot, sub-slot, slot, msec, sec, DRX cycles), or a first number of SS set(s), or a first number of SS set group(s)) in the first active DL BWP of the first serving cell and/or in one or some second BWPs of one or some second serving cells for a time duration. The first number of PDCCH occasion(s) (or a first number of time units (e.g., symbol, mini-slot, sub-slot, slot, msec, sec, DRX cycles) or a first number of SS set(s) or a first number of SS set group(s)) may be configured in RRC and/or indicated by the PDCCH with control information. The UE may stop monitoring (or may not monitor or may skip monitoring) a first number of PDCCH occasion(s) (or a first number of time units (e.g., symbol, mini-slot, sub-slot, slot, msec, sec, DRX cycles), a first number of SS set(s), or a first number of SS set group(s)) in the second BWP of the one or some second serving cells for the time duration at least a time offset after receiving at least one of the control information and the PDCCH.

Specifically, in one implementation, the PDCCH with the control information may be a PDCCH skipping indication. In another implementation, the first number may be (pre-)configured by RRC parameters and/or be indicated by the PDCCH. In another implementation, the second serving cell(s) may be (pre-)configured by RRC parameters (e.g., via a cell index and/or a cell list) or be indicated by the PDCCH (e.g., via a cell index). In another implementation, the second serving cell(s) may be (pre-)configured by RRC parameters (e.g., via a cell group and/or a cell list), and the PDCCH may indicate which cell group and/or cell list via a bit-map. In another implementation, a reference time for starting the time offset may be the first symbol or the last symbol that carries the control information.

In some implementations, if/when a UE receives/decodes/detects a PDCCH with a control information in a first active DL BWP of a first serving cell and/or the UE is performing some specific procedures (e.g., a BFR procedure and/or a RA procedure and/or an SR procedure) in one or some second BWPs of one or some second serving cells, the UE may ignore one or some DCI fields in the control information in one or some second BWPs in the one or some second serving cells under one or some conditions. Alternatively, the one or some DCI fields may be absent in one or some conditions.

In some implementations, if/when a UE receives/decodes/detects a PDCCH with a control information in a first active DL BWP of a first serving cell and/or the UE is performing some specific procedures (e.g., a BFR procedure and/or a RA procedure and/or an SR procedure) in one or some second BWPs in one or some second serving cells, the UE may need to always monitor the PDCCH (e.g., in one or some conditions) and/or a specific SS regardless of the indication/control information of the PDCCH. Alternatively, the UE may not apply the PDCCH skip.

In one implementation, if/when a UE receives/decodes/detects a PDCCH with a control information (which may indicate the PDCCH skipping) and the UE is performing a RA procedure and/or if a RA preamble is transmitted, the UE may need to monitor the PDCCH (e.g., on an SS (set) configured by one RACH configuration) for a RAR identified by one RA-RNTI, e.g., while a RAR window is running, regardless of the indication/control information of the PDCCH. Specifically, the UE may ignore the indication/control information of the PDCCH in this condition. Specifically, the indication/control information of the PDCCH may not be applicable in this condition. Specifically, in one example, the above condition does not include a RAR window being running.

In one implementation, if/when a UE receives/decodes/detects a PDCCH with a control information (which may indicate the PDCCH skipping) and the UE is performing a BFR procedure and/or if the contention-free RA Preamble for a BFR request is transmitted by the UE, the UE may need to monitor the PDCCH on the SS (set) indicated by a parameter recoverySearchSpaceId of the SpCell identified by one C-RNTI or one MCS-C-RNTI, e.g., while the RAR window is running, regardless of the indication/control information of the PDCCH. Specifically, the UE may ignore the indication/control information of the PDCCH in this condition. Specifically, the indication/control information of the PDCCH may not be applicable in this condition. In one implementation, if/when a UE receives/decodes/detects a PDCCH with a control information (which may indicate the PDCCH skipping) and the UE is performing an SCell BFR procedure and/or if one or some specific MAC CEs is(are) transmitted by the UE, the UE may need to monitor the PDCCH, e.g., when the SCell BFR MAC CE and/or one or some of the specific MAC CEs is(are) sent and the PDCCH (e.g., addressed to the C-RNTI) indicating UL grant for a new transmission is not received for the HARQ process that is used for transmission of the SCell BFR MAC CE and/or one or some of the specific MAC CE, regardless of the indication/control information of the PDCCH. Specifically, the UE may ignore the indication/control information of the PDCCH in this condition. Specifically, the indication/control information of the PDCCH may not be applicable in this condition.

In one implementation, if/when a UE receives/decodes/detects a PDCCH with a control information (which may indicate the PDCCH skipping) and the UE is performing a RA procedure and/or if a Msg3 is transmitted by the UE, the UE may need to monitor the PDCCH while the RA contention resolution timer is running regardless of the indication/control information of the PDCCH. Specifically, the UE may ignore the indication/control information of the PDCCH in this condition. Specifically, the indication/control information of the PDCCH may not be applicable in this condition.

In one implementation, if/when a UE receives/decodes/detects a PDCCH with a control information (which may indicate the PDCCH skipping) and an SR is considered as pending, the UE may need to monitor the PDCCH, e.g., when the SR is sent on one PUCCH and is pending, regardless of the indication/control information of the PDCCH. Specifically, the UE may ignore the indication/control information of the PDCCH in this condition. Specifically, the indication/control information of the PDCCH may not be applicable in this condition.

In one implementation, if/when a UE receives/decodes/detects a PDCCH with a control information (which may indicate the PDCCH skipping) and a specific DRX timer is running, the UE may need to monitor the PDCCH, regardless of the indication/control information of the PDCCH. Specifically, the UE may ignore the indication/control information of the PDCCH in this condition. Specifically, the indication/control information of the PDCCH may not be applicable in this condition. In one example, the specific DRX timer may be at least one of drx-RetransmissionTimerDL and drx-RetransmissionTimerUL.

In some implementations, the control information may indicate the UE to stop monitoring a first number of PDCCH occasion(s) (or a first number of time units (e.g., symbol, mini-slot, sub-slot, slot, ms, s, DRX cycles) or a first number of SS set(s) or a first number of SS set group(s)) in one or some second BWPs of one or some second serving cells for a time duration.

In some implementations, if/when a UE receives/decodes/detects a PDCCH with a control information in a first active DL BWP of a first serving cell, the UE may stop monitoring (or may not monitor or may skip monitoring) a first number of PDCCH occasion(s) (or a first number of time units (e.g., symbol, mini-slot, sub-slot, slot, ms, s, DRX cycles) or a first number of SS set(s) or a first number of SS set group(s)) in one or some second BWPs of some (and/or one, and/or all, and/or some, and/or all but except the serving cell where the SR of the UE is pending on (and/or where the UE is performing the BFR procedure and/or where the UE is performing the RA procedure)) of serving cell(s) in one or some second serving cells for a time duration at least a time offset after receiving at least one of the control information and the PDCCH.

In some implementations, the control information may be described with at least one of the following items:
The control information may include indication/information to one or some UEs;
The control information may include indication/information to one or some serving cells;
The control information may be related to stop monitoring (or be related to not monitor or be related to skip monitoring) a first number of PDCCH occasion(s) (or a first number of time units (e.g., symbol, mini-slot, sub-slot, slot, msec, sec, DRX cycles, etc.) or a first number of SS set(s) or a first number of SS set group(s)) for a time duration;
The control information may be applied by the UE until the UE receives the next control information. The UE may store and/or maintain the control information when the UE receives the control information. The UE may apply the control information when the UE receives the control information and/or when a condition occurs. The UE may release/delete/discard the control information upon the UE receives the next control information;
The control information may include indication/information related to the SS set (group) switching;
The control information may include indication/information related to the PDCCH skipping;
The control information may include one or more wake-up indications;
The control information may include indication/information related to the SCell dormancy;
One NW may (always) transmit the control information inside and/or outside an Active Time;
One NW may (always) transmit the control information outside the Active Time if an RRC parameter (e.g. DCP-config and/or ps-WakeUp-r16) is configured;
One NW may not (or may never) transmit the control information outside the Active Time if an RRC parameter (e.g. DCP-config and/or ps-Wake Up-r16) is not configured;
The UE may (always) be expected to monitor/receive/decode/detect the control information outside the Active Time;
The UE may (always) be expected to monitor/receive/decode/detect the control information outside the Active Time if an RRC parameter (e.g. DCP-config and/or ps-WakeUp-r16) is configured;
The UE may not be expected (or may never be expected) to monitor/receive/decode/detect the control information outside the Active Time if an RRC parameter (e.g. DCP-config and/or ps-WakeUp-r16) is not configured;
One NW may not (or may never) transmit the control information inside the Active Time;
The UE may (always) be expected not to monitor/receive/decode/detect the control information inside the Active Time;
The control information may be a DCI;
The control information may be a DCI scrambled by the PS-RNTI (e.g., DCP);
The control information may be a DL control signal/information/channel;
The control information may be a DCI format in the USS/CSS;
The control information may be at least one of a DCI format 0_0, a DCI format 0_1, a DCI format 0_2, a DCI format 1_0, a DCI format 1_1, a DCI format 1_2, a DCI format 2_0, a DCI format 2_1, a DCI format 2_2, a DCI format 2_3, a DCI format 2_4, a DCI format 2_5, a DCI format 2_6; and
The control information may (only) be applicable to activated serving cell, in other words, the control information may not be applicable to deactivated serving cell. More specifically, the control information may not be applicable to a dormancy cell (e.g., the serving cell which active BWP is a dormancy BWP).

In some implementations, the first serving cell may be at least one of:
The SpCell,
The PCell, and
The configured serving cell(s), e.g., the PCell, the SCell(s) and/or the PSCell(s).

In some implementations, the first number of PDCCH occasion(s) (or a first number of SS set(s) or a first number of SS set group(s)) may be described with at least one of the following items:
It may be related to (or may be configured in or may be monitored in) one or some USS sets;
It may be related to (or may be configured in or may be monitored in) one or some CSS sets;
It may be related to (or may be configured in or may be monitored in) one or some specific SS sets (with a specific SS ID);
It may be related to (or may be configured in or may be monitored in) one or some specific CORESET(s) (with a specific CORESET ID); and
It may be related to (or may be configured with) one or some specific SS set group(s) (with or without a specific SS set group ID).

In some implementations, the one or some specific SS set(s) (or CORESET(s) or SS set group(s)) may be related to one or some procedure(s) as described in the following:
The BFR procedure (initiated by the UE), where the specific SS set may be indicated by the parameter recoverySearchSpaceId configured in the parameter BeamFailureRecoveryConfig;
The RA procedure (initiated by the UE), where the specific SS set may be a Type1-PDCCH CSS set; and
The SR procedure (initiated by the UE).

In some implementation, the one or some specific SS set groups (with or without a specific SS set group ID) may be described with at least one of the following items:
The configured SS set group ID (e.g., searchSpaceGroupIdList) is 00/01/10/11; and
The configured SS set group is without SS set group ID (e.g., searchSpaceGroupIdList is not provided).

In some implementations, the one or some second BWPs may be at least one of the following:
A DL BWP;
A UL BWP;
A BWP that may be same as the first active DL BWP;
An active BWP; and
A dormant (or an inactive) BWP.

In some implementations, the one or some second serving cells may be described with at least one of the following items:
The one or some second serving cells may be (or may not be) the first serving cell;
The one or some second serving cells may include (or may not include) the first serving cell;
The one or some second serving cells may be a serving cell group associated with SS set group switching (and/or associated with SS set and/or associated with the SCell dormancy and/or associated with the PDCCH skipping);
The one or some second serving cells may be one or some of serving cell groups associated with SS set group switching (and/or associated with the SCell dormancy and/or associated with the PDCCH skipping);
The one or some second serving cells may be a serving cell group configured in higher layers (e.g. RRC);
The one or some second serving cells may be one or some of serving cell groups configured in higher layers (e.g. RRC);
The one or some second serving cells may be indicated (among some of serving cell groups) by (one or some information fields in) the control information;
The one or some second serving cells may be one or some of serving cell groups associated with (or related to or configured in) cellGroupsForSwitchList;
The one or some second serving cells may be one or some of serving cell groups associated with (or related to or configured with) a specific group ID (e.g., DormancyGroupID); and
The one or some second serving cells may be one (or some) serving cell(s) in the serving cell group(s).

In some implementations, the cell group may be at least one of the following:
A group of serving cell(s) configured in RRC parameter(s) (e.g., SearchSpaceSwitchConfig, and/or CellGroupForSwitch, and/or cellGroupsForSwitchList, and/or DormancyGroupID, and/or DormancyGroupID in dormancyGroupWithinActiveTime, and/or DormancyGroupID in dormancyGroupOutsideActiveTime);
A group of configured SCells from the number of groups of configured SCells for the Dormancy indication;
A configured cell group for the SS set (group) indication/switching;
A configured cell group for the PDCCH skipping; and
A configured cell group for the Dormancy indication (e.g., a dormancy group) and/or the SS set (group) indication/switching and/or the PDCCH skipping indication/switching and/or the control resource set indication/switching.

In some implementations, the time duration may be described with at least one of the following items:
The time duration may be configured in the RRC;
The time duration may be indicated by the control information;
The time duration may be configured in the RRC and indicated by the control information;
The time duration may be indicated/represented in different units, where the time duration may be a set of symbols (and/or a set of slots and/or a set of sub-slots) (with the smallest/largest SCS among the one or more than one second serving cells or with the SCS for the BWP receiving the control information); and
The time duration may be indicated/represented in the unit of msec.

In some implementations, the time offset may be described with at least one of the following items:
The time offset may include a processing time, which is required for decoding and/or parsing the control information, and/or a time duration for the control information to take effect;
The time offset may be indicated/represented in different units, where the time offset may be at least one of a set of symbols (with the smallest/largest SCS among the one or some second serving cells), a set of slots (with the smallest/largest SCS among the one or some second serving cells), a set of sub-slots (with the smallest/largest SCS among the one or some second serving cells), and a processing time in unit of msec;
The time offset may align with the SS set (group) switching indication (or align with the SCell dormancy indication or align with the BWP switch indication);
The time offset may be the same value as the SS set (group) switching indication (or the SCell dormancy indication or the BWP switch indication);
The time offset may align with the processing time related to the SS set (group) switching (or align with the SCell dormancy or align with the BWP switch indication). The time offset may be the same value as the processing time related to the SS set (group) switching indication (or the SCell dormancy indication BWP switch indication);
If/when the control information may include information/indication for the SS set (group) switching and/or for the SCell dormancy and/or for the PDCCH skipping, the time offset may be determined by the processing time related to the PDCCH skipping and/or the SS set (group) switching and/or for the SCell dormancy;
If/when one or some second control information other than the control information may include information/indication for the SS set (group) switching and/or for the SCell dormancy and/or for the PDCCH skipping, the time offset may be determined by the processing time related to the PDCCH skipping and/or the SS set (group) switching and/or for the SCell dormancy;
If/when the control information may include information/indication for the SS set (group) switching and/or for the SCell dormancy and/or for the PDCCH skipping, the time offset may be determined by the shortest/longest processing time among the processing time related to the SS set (group) switching and/or the processing time related to the SCell dormancy and/or the processing time related to the PDCCH skipping;
If/when one or some second control information other than the control information include information/indication for the SS set (group) switching and/or for the SCell dormancy and/or for the PDCCH skipping, the time offset may be determined by the shortest/longest processing time among the processing time related to the SS set (group) switching and/or the processing time related to the SCell dormancy and/or the processing time related to the PDCCH skipping;
If/when the control information may include information/indication for the SS set (group) switching and/or for the SCell dormancy and/or for the PDCCH skipping, the time offset for applying the PDCCH skipping and/or the SS set (group) switching and/or for the SCell dormancy may align with one and another time offset;
If/when one or some second control information other than the control information include information/indication for the SS set (group) switching and/or for the SCell dormancy and/or for the PDCCH skipping, the time offset for applying the PDCCH skipping and/or the SS set (group) switching and/or for the SCell dormancy may align with one and another time offset;
The starting point of the time offset may be at the last symbol of a PDCCH with the control information; and
Each of the one or some second serving cells may have different or a same time offset.

In some implementations, the PDCCH skipping may be replaced with the stop of monitoring (or may not monitor) a first number of PDCCH occasion(s) (or a first number of SS set(s) or a first number of SS set group(s)).

In some implementations, when an SR is triggered, it may be considered as pending until it is cancelled.

In some implementations, the one or some DCI fields may be related to (and/or may be used for) the SS (set) switching (and/or the SS set group switching and/or the PDCCH skipping and/or the SCell dormancy).

In some implementations, the one or some conditions may be described with at least one of the following items:
The UE is performing the RA/BFR/SR procedure;
The timer is running;
The timer is related to the RA (e.g., a RAR window)/BFR/SR, and/or the DRX;
The UE is transmitted the RA (e.g., a preamble, Msg1, Msg3)/BFR (e.g., a preamble, Msg1, Msg3, SCell BFR MAC CE)/SR request (e.g., on the PUCCH);
The UE is transmitted one or some specific MAC CEs; and
The UE is not received the PDCCH related to a specific MAC CE (e.g., the PDCCH addressed to the C-RNTI indicating a UL grant for a new transmission is not received for the HARQ process used for the transmission of the specific MAC CE).

In some implementations, the one or some of the specific MAC CEs may be at least one of the following items:
A C-RNTI MAC CE or data from a UL-CCCH;
An SL Configured Grant Confirmation MAC CE;
A LBT failure MAC CE;
A MAC CE for the SL-BSR prioritized as introduced in 3GPP;
A MAC CE for the BSR, with exception of the BSR included for padding;
A Single Entry PHR MAC CE or a Multiple Entry PHR MAC CE;
A MAC CE for a number of Desired Guard Symbols;
A MAC CE for a Pre-emptive BSR;
A MAC CE for the SL-BSR, with exception of the SL-BSR prioritized as introduced in 3GPP and the SL-BSR included for padding;
Data from any Logical Channel, except data from a UL-CCCH;
A MAC CE for a Recommended bit rate query;
A MAC CE for the BSR included for padding;
A MAC CE for the SL-BSR included for padding.

In some implementations, if/when a UE detects a DCI format 2_6 related to the PDCCH skipping in the PDCCH in an active DL BWP of a PCell and the DCI indicates to the UE to skip the PDCCH monitoring for 4 slots, the UE may stop monitoring the SS set(s) configured in the USS for 4 slots and may continuously monitor the SS set(s) configured in the CSS. The PDCCH skipping may be applied to an active BWP of one or some serving cells in a configured cell group indicated by the DCI. The PDCCH skipping may start at the beginning of a slot that is at least 10 symbols with the smallest SCS among all configured serving cell(s) in the configured cell group after the last symbol of the PDCCH with the DCI format 2_6. In another implementation, such 10-symbol offset is determined based on the SCS of the serving cell that receives the DCI format 2_6.

In some implementations, if/when a UE detects a DCI format 1_1 related to the PDCCH skipping in the PDCCH in an active DL BWP of a PCell and the DCI indicates to the UE to skip the PDCCH monitoring for 4 slots, the UE may stop monitoring the SS set(s) with the SS set group ID “01” and “10” for 4 slots and may continuously monitor the SS set(s) with the configured SS set group ID “11” (and/or without the SS set ID). The PDCCH skipping may be applied to an active BWP of one or some serving cells in a configured cell group indicated by the DCI. The PDCCH skipping may start at the beginning of a slot that is at least 10 symbols with the smallest SCS among all configured serving cell(s) in the configured cell group after the last symbol of the PDCCH with the DCI format 1_1. In another implementation, such 10-symbol offset is determined based on the SCS of the serving cell that receives the DCI format 1_1.

In some implementations, if/when a UE detects a DCI format 1_1 related to the PDCCH skipping in the PDCCH in an active DL BWP of a PCell and the DCI indicates to the UE to skip the PDCCH monitoring for 10 symbols, the UE may stop monitoring the SS set(s) other than the DCI format 1_1 related to the BFR procedure (and/or the RA procedure and/or the SR procedure) for 10 symbols. The PDCCH skipping may be applied to an active BWP of one or some serving cells in a configured cell group indicated by the DCI. The PDCCH skipping may start at the beginning of a slot that is at least 10 symbols with the smallest SCS among all configured serving cell(s) in the configured cell group after the last symbol of the PDCCH with the DCI format 1_1. In another implementation, such 10-symbol offset is determined based on the SCS of the serving cell that receives the DCI format 1_1.

In some implementations, if/when a UE detects a DCI format 1_1 related to the PDCCH skipping in an active DL BWP of a PCell and the UE is performing the RA procedure and/or the BFR procedure in the Pcell, the UE may ignore one or some DCI fields in the DCI format 1_1 indicating the PDCCH skipping in the Pcell (e.g., the UE may not skip the PDCCH monitoring in the Pcell) before the UE detects the DCI format 1_1 (e.g., scrambled by the C-RNTI) related to the RAR. The UE may stop monitoring the PDCCH occasion(s) in all other serving cells (e.g., except the PCell) in an active BWP of a configured PDCCH skipping group. The configured PDCCH skipping group may be configured in the RRC and indicated by the DCI format 1_1. The PDCCH skipping may start at the beginning of a slot that is at least 10 symbols with the smallest SCS among all configured serving cell(s) in the configured cell group after the last symbol of the PDCCH with the DCI format 1_1. In one implementation, such 10-symbol offset is determined based on the SCS of the serving cell that receives the DCI format 1_1. In another implementation, the PDCCH skipping indicated by the DCI format 1_1 may not be ignored (e.g., the UE may skip the PDCCH monitoring in the PCell) if the PDDCH is detected in a specific SS, e.g., an SS set provided by recoverySearchSpaceId.

In some implementations, if/when a UE detects a DCI format 1_1 related to the PDCCH skipping in an active DL BWP of a PCell and the UE initiates the SR in a serving cell with ID 2, the UE may ignore one or some DCI fields in the DCI format 1_1 indicating the PDCCH skipping in the serving cell with ID 2 and the UE may monitor PDCCH occasion(s) in other serving cells (except the serving cell with ID 2) in an active BWP of a configured PDCCH skipping group. The configured PDCCH skipping group may be configured in the RRC and indicated by the DCI format 1_1. The PDCCH skipping may start at the beginning of a slot that is at least 10 symbols with the smallest SCS among all configured serving cell(s) in the configured cell group after the last symbol of the PDCCH with the DCI format 1_1. In another implementation, such 10-symbol offset is determined based on the SCS of the serving cell that receives the DCI format 1_1.

In some implementations, if/when a UE detects a DCI format 0_1 related to the PDCCH skipping in an active DL BWP of a PCell and an SR is sent on a PUCCH to be considered as pending in a serving cell with ID 2, the UE may ignore one or some DCI fields in the DCI format 0_1 indicating the PDCCH skipping in all serving cell(s) of a configured PDCCH skipping group. The configured PDCCH skipping group may be configured in the RRC and indicated by the DCI format 0_1.

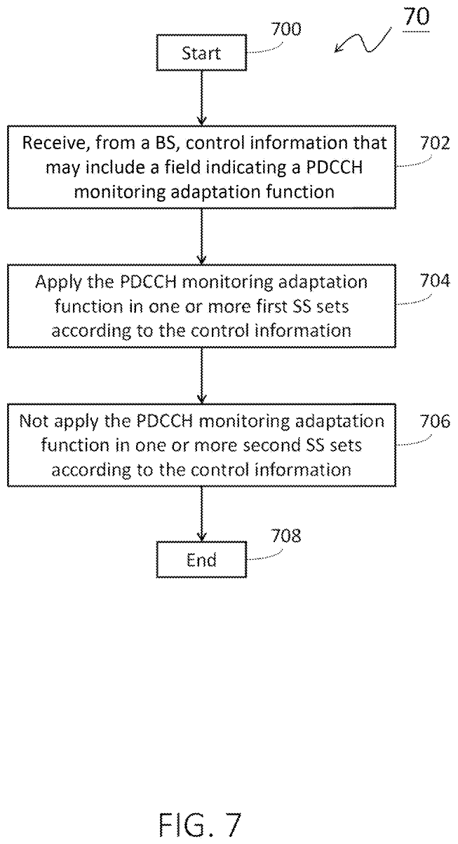

FIG. 7 is a flowchart illustrating a process 70 performed by a UE for performing SDT with a BS, according to an example implementation of the present disclosure. As shown in FIG. 7, the process 70 for the UE may include the following actions:
Action 700: Start.
Action 702: Receive, from a BS, control information that may include a field indicating a PDCCH monitoring adaptation function.
Action 704: Apply the PDCCH monitoring adaptation function in one or more first SS sets, according to the control information.
Action 706: Not apply the PDCCH monitoring adaptation function in one or more second SS sets, according to the control information.
Action 708: End.

In some implementations, the UE may be configured to receive the control information from the BS in action 702, where the control information includes the field indicating the PDCCH monitoring adaptation function. Specifically, the PDCCH monitoring adaptation function may refer to at least one of a PDCCH skipping function and an SS set group switching function. In actions 704 and 706, the UE may be configured to, according to the control information, apply the PDCCH monitoring adaptation function in the one or more first SS sets and not apply the PDCCH monitoring adaptation function in the one or more second SS sets. Specifically, at least one of the one or more first SS sets may refer to a USS. Specifically, at least one of the one or more second SS sets may refer to a Type-1 PDCCH CSS or an SS set related to an RA procedure.

In some implementations, the process 70 further configures the UE to perform a specific procedure. Specifically, the specific procedure refers to at least one of an RA procedure, an SR procedure, a BFR procedure, and a procedure for DRX.

In some implementations, the process 70 further configures the UE to ignore the field indicating the PDCCH monitoring adaptation function while not applying the PDCCH monitoring adaptation function in the one or more second SS sets. In other implementations, the operation of not applying the PDCCH monitoring adaptation function in the one or more second SS sets may further configure the UE not to apply the PDCCH monitoring adaptation function in the one or more second SS sets regardless of a field in the control information indicating the PDCCH monitoring adaptation function. In other implementations, the operation of not applying the PDCCH monitoring adaptation function in the one or more second SS sets may further configure the UE not to perform the PDCCH monitoring adaptation function indicated in the field of the control information. In other implementations, the operation of not applying the PDCCH monitoring adaptation function in the one or more second SS sets may be described that the one or more second SS sets are not effected by the field of the control information indicating the PDCCH monitoring adaptation function.

In some implementations, the process 70 further configures the UE to initiate at least one of a first timer and a second timer while receiving the control information; apply the PDCCH monitoring adaptation function in the one or more first SS sets according to the control information if the first timer is running; and not apply the PDCCH monitoring adaptation function in the one or more second SS sets according to the control information if the second timer is running. Specifically, the first timer or the second timer is triggered if a request or a specific MAC CE on a PUCCH is transmitted to the BS or the UE fails to receive a PDCCH corresponding to the specific MAC CE.

In some implementations, all the designs/embodiments/implementations introduced within this disclosure are not limited to be applied for dealing with the problem mention within this disclosure. For example, the described embodiments may be applied to solve other problems that exist in the RAN of cellular wireless communication systems. In some implementations, all of the numbers listed within the designs/embodiments/implementations introduced within this disclosure are just examples and for illustration, for example, of how the described methods are executed.

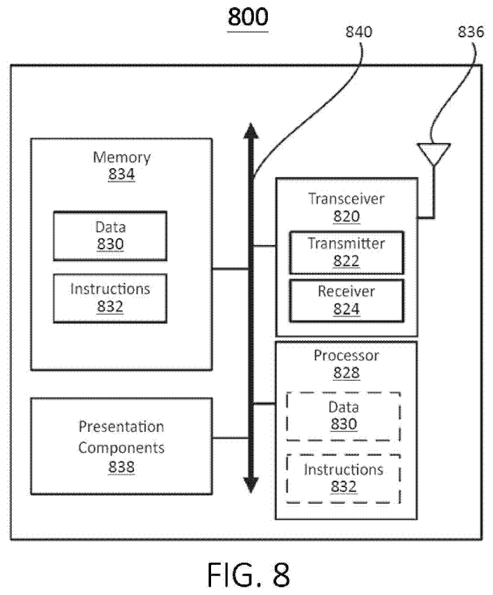

FIG. 8 is a block diagram illustrating a node 800 for wireless communication according to an example implementation of the present disclosure. As illustrated in FIG. 8, the node 800 may include a transceiver 820, a processor 828, a memory 834, one or more presentation components 838, and at least one antenna 836. The node 800 may also include a radio frequency (RF) spectrum band module, a BS communications module, a network communications module, and a system communications management module, Input/Output (I/O) ports, I/O components, and a power supply (not illustrated in FIG. 8).

Each of the components may directly or indirectly communicate with each other over one or more buses 840. The node 800 may be a UE or a BS that performs various functions disclosed with reference to FIGS. 1 through 7.

The transceiver 820 has a transmitter 822 (e.g., transmitting/transmission circuitry) and a receiver 824 (e.g., receiving/reception circuitry) and may be configured to transmit and/or receive time and/or frequency resource partitioning information. The transceiver 820 may be configured to transmit in different types of subframes and slots including but not limited to usable, non-usable, and flexibly usable subframes and slot formats. The transceiver 820 may be configured to receive data and control channels.

The node 800 may include a variety of computer-readable media. Computer-readable media may be any available media that may be accessed by the node 800 and include both volatile and non-volatile media, and removable and non-removable media.

The computer-readable media may include computer storage media and communication media. Computer storage media may include both volatile and non-volatile media, and removable and non-removable media implemented in any method or technology for storage of information such as computer-readable instructions, data structures, program modules or data.

Computer storage media may include RAM, ROM, EPROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media may not include a propagated data signal. Communication media may typically embody computer-readable instructions, data structures, program modules or other data in a modulated data signal such as a carrier wave or other transport mechanism and include any information delivery media.

The term “modulated data signal” means a signal that has one or more of its characteristics set or changed in such a manner as to encode information in the signal. Communication media may include wired media such as a wired network or direct-wired connection, and wireless media such as acoustic, RF, infrared and other wireless media. Combinations of any of the previously listed components should also be included within the scope of computer-readable media.

The memory 834 may include computer-storage media in the form of volatile and/or non-volatile memory. The memory 834 may be removable, non-removable, or a combination thereof. Example memory may include solid-state memory, hard drives, optical-disc drives, etc. As illustrated in FIG. 8, the memory 834 may store computer-readable, computer-executable instructions 832 (e.g., software codes) that are configured to cause the processor 828 to perform various functions disclosed herein, for example, with reference to FIGS. 1 through 7. Alternatively, the instructions 832 may not be directly executable by the processor 828 but be configured to cause the node 800 (e.g., when compiled and executed) to perform various functions disclosed herein.

The processor 828 (e.g., having processing circuitry) may include an intelligent hardware device, e.g., a Central Processing Unit (CPU), a microcontroller, an ASIC, etc. The processor 828 may include memory. The processor 828 may process the data 830 and the instructions 832 received from the memory 834, and information transmitted and received via the transceiver 820, the base band communications module, and/or the network communications module. The processor 828 may also process information to be sent to the transceiver 820 for transmission via the antenna 836 to the network communications module for transmission to a core NW.

One or more presentation components 838 may present data indications to a person or another device. Examples of presentation components 838 may include a display device, a speaker, a printing component, and a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1-16. (canceled)

17. A method performed by a User Equipment (UE) for saving power, the method comprising:
receiving, from a Base Station (BS), control information that includes a Physical Downlink Control Channel (PDCCH) monitoring adaptation field, wherein the PDCCH monitoring adaptation field indicates a PDCCH skipping function; and
monitoring, regardless of the PDCCH skipping function indicated by the PDCCH monitoring adaptation field, a PDCCH in a case that a Scheduling Request (SR) is transmitted on a Physical Uplink Control Channel (PUCCH) and is determined to be pending.

18. The method of claim 17, wherein the PDCCH monitoring adaptation field is further used to indicate a search space (SS) set group switching function.

19. The method of claim 17, further comprising:
not applying the PDCCH skipping function in a case that an RA contention resolution timer is running.

20. The method of claim 17, further comprising:
monitoring, regardless of the PDCCH skipping function indicated by the PDCCH monitoring adaptation field, the PDCCH in a case that an RA contention resolution timer is running.

21. The method of claim 17, wherein the control information is detected in a UE-specific search space (USS).

22. A User Equipment (UE) for saving power, the UE comprising:
one or more processors; and
at least one memory coupled to the one or more processors, wherein the at least one memory stores one or more computer-executable-instructions that, when executed by the one or more processors, cause the UE to:
receive, from a Base Station (B S), control information that includes a Physical Downlink Control Channel (PDCCH) monitoring adaptation field, wherein the PDCCH monitoring adaptation field indicates a PDCCH skipping function; and
monitor, regardless of the PDCCH skipping function indicated by the PDCCH monitoring adaptation field, a PDCCH in a case that a Scheduling Request (SR) is transmitted on a Physical Uplink Control Channel (PUCCH) and is determined to be pending.

23. The UE of claim 22, wherein the PDCCH monitoring adaptation field indicates the PDCCH skipping function and a search space (SS) set group switching function.

24. The UE of claim 22, wherein the one or more computer-executable instructions, when executed by the one or more processors, further cause the UE to:
not apply the PDCCH skipping function in a case that an RA contention resolution timer is running.

25. The UE of claim 22, wherein the one or more computer-executable instructions, when executed by the one or more processors, further cause the UE to:
monitor, regardless of the PDCCH skipping function indicated by the PDCCH monitoring adaptation field, the PDCCH in a case that an RA contention resolution timer is running.

26. The UE of claim 22, wherein the control information is detected in a UE-specific search space (US S).

27. A Base Station (BS) for saving power, the BS comprising:
one or more processors; and
at least one memory coupled to the one or more processors, wherein the at least one memory stores one or more computer-executable-instructions that, when executed by the one or more processors, cause the BS to:
transmit, to a User Equipment (UE), control information that includes a Physical Downlink Control Channel (PDCCH) monitoring adaptation field, wherein:
the PDCCH monitoring adaptation field indicates a PDCCH skipping function; and
a PDCCH is monitored, by the UE, regardless of the PDCCH skipping function indicated by the PDCCH monitoring adaptation field in a case that a Scheduling Request (SR) is received on a Physical Uplink Control Channel (PUCCH) and is determined to be pending.

28. The BS of claim 27, wherein the PDCCH monitoring adaptation field indicates the PDCCH skipping function and a search space (SS) set group switching function.

29. The BS of claim 27, wherein the PDCCH skipping function is not applied in a case that an RA contention resolution timer is running.

30. The BS of claim 27, wherein the PDCCH is monitored, regardless of the PDCCH skipping function indicated by the PDCCH monitoring adaptation field, in a case that an RA contention resolution timer is running.

31. The BS of claim 27, wherein the control information is transmitted in a UE-specific search space (USS).
